(19) United States
(12) Patent Application Publication
(10) Pub. No.: US 2011/0102701 A1
(43) Pub. Date: May 5, 2011

(54) LIQUID CRYSTAL DISPLAY DEVICE

(75) Inventors: HSUAN-YU TENG, Miao-Li County (TW); MEI-FANG HUANG, Miao-Li County (TW)

(73) Assignee: CHIMEI INNOLUX CORPORATION, Miao-Li County (TW)

(21) Appl. No.: 12/902,164

(22) Filed: Oct. 12, 2010

(30) Foreign Application Priority Data
Oct. 30, 2009 (CN) 200910309080.8

(51) Int. Cl. G02F 1/1335; G02F 1/1333

(52) U.S. Cl. 349/58

(57) ABSTRACT

A liquid crystal display (LCD) device includes a first frame, a second frame, and an LCD module received cooperatively therebetween. The LCD module includes a liquid crystal panel and a backlight module. The second frame includes a bottom plate and a side structure substantially extending from the bottom plate. A space comprising a first opening is defined by the side structure and the bottom plate, and an extending portion extends from the side structure toward the space. The backlight module is disposed on the bottom plate, and the liquid crystal panel is disposed on and supported by the extending portion.

### BACKGROUND

1. Technical Field

The present disclosure generally relates to display technology, and particularly to a liquid crystal display (LCD) device.

2. Description of Related Art

LCD devices are commonly used as displays for electronic apparatuses such as television, notebooks, and the like, due to not only good quality image using little power, but also having a compact profile. The LCD device generally includes an LCD module, a bezel, and a back panel cooperatively fitting the bezel to receive the LCD module. The bezel and the back panel not only protect and hold the LCD module, but also provide the exterior of the LCD device with a visually appealing aspect.

A typical LCD module includes a front casing, a plastic frame, and a rear casing, to fix and hold inner components, such as a liquid crystal panel, a backlight module, and others, such that the LCD device requires a thick configuration, compromising requirements for compact device profile.

What is needed, therefore, is an LCD device which can overcome the described limitations.

### SUMMARY

An LCD device includes a first frame, a second frame, and an LCD module received cooperatively therebetween. The LCD module includes a liquid crystal panel and a backlight module. The second frame includes a bottom plate and a side structure extending from the bottom plate. A space having a first opening is defined by the side structure and the bottom plate. An extending portion extends from the side structure toward the space. The backlight module is disposed on the bottom plate, and the liquid crystal panel is disposed on and supported by the extending portion.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an exploded view of a first embodiment of an LCD device.

FIG. 2 is an assembly view of part of the LCD device of FIG. 1.

FIG. 3 is a cross-section of FIG. 2 taken along line

FIG. 4 is an exploded view of a second embodiment of an LCD device.

### DETAILED DESCRIPTION

Reference will now be made to the drawings to describe various embodiments in detail.

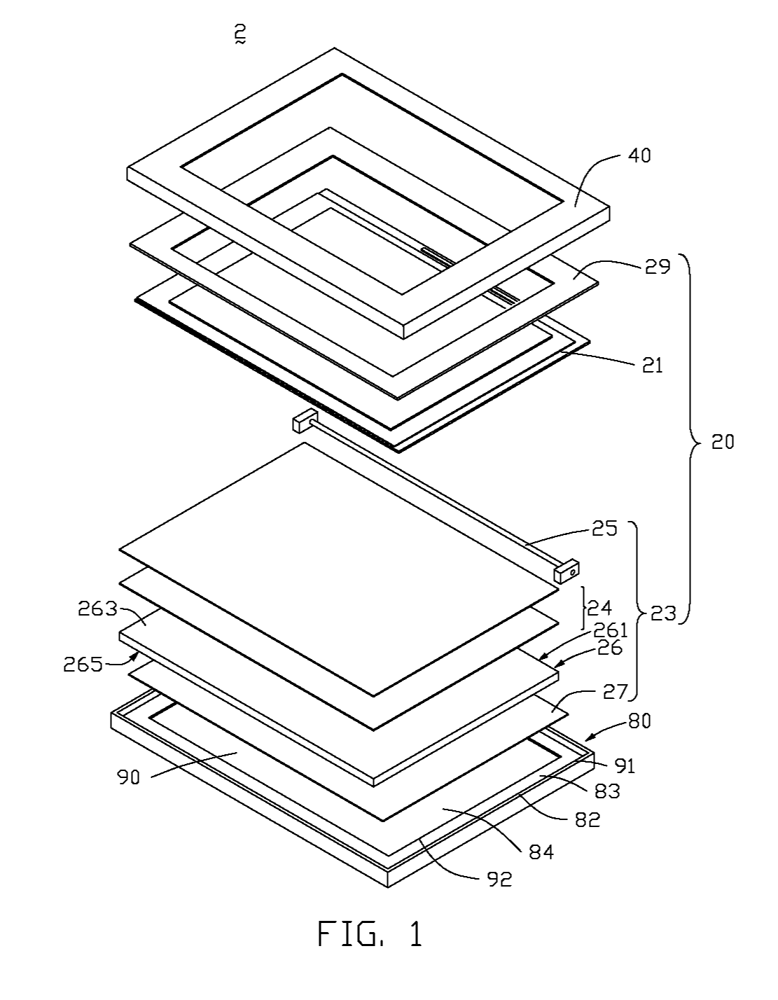

Referring to FIG. 1, an exploded view of a first embodiment of an LCD device 2 is shown. The LCD device 2 includes a first frame 40, an LCD module 20, and a second frame 80. The first frame 40 may be a bezel, and the second frame 80 may be a back panel. The first frame 40 and the second frame 80 cooperatively form an accommodating space to receive the LCD module 20. The first frame 40 and the second frame 80 may attach via a locking means utilizing protrusions and notches, or via fasteners, for example.

The second frame 80 includes a bottom plate 84 and a side structure (not labeled) extending from the bottom plate 84. The side structure includes four sides 82 connected end to end. The four sides 82 and the bottom plate 84 cooperatively form a space 90. The space 90 is substantially rectangular and has a first opening 91. A capacity of the space 90 is substantially the same as a volume of the LCD module 20.

An extending portion 83 extends from the side structure toward the space 90. The extending portion 83 is parallel to the bottom plate 84 and a determined distance from the bottom plate 84. The extending portion 83 surrounds a second opening 92 in the space 90. An area of the second opening 92 is less than that of the first opening 91. If the LCD device 2 is small, the bottom plate 84 and the side structure may both be plastic. If the LCD device 2 is large, the bottom plate 84 may be metal, the side structure may be plastic, and the bottom plate 84 and the side structure can be formed integrally by insert molding.

The LCD module 20 includes a light-shielding tape 29, a liquid crystal panel 21, and a backlight module 23. The backlight module 23 disposed on the bottom plate 84 includes a plurality of optical films 24, a light source 25, a light guide plate 26, and a reflector 27. The light source 25 may be a tube lamp. A sum of a thickness of the light guide plate 26 and a thickness of the reflector 27 is substantially equal to the distance between the extending portion 83 and the bottom plate 84. A thickness of the optical films 24 is slightly less than that of the extending portion 83. The light guide plate 26 includes a light incident surface 261, a light emitting surface 263 adjacent to the light incident surface 261, and a bottom surface 265 opposite to the light emitting surface 263. The liquid crystal panel 21 may include two glass substrates, and the glass substrates may be tempered glass to increase intensity strength of the liquid crystal panel 21.

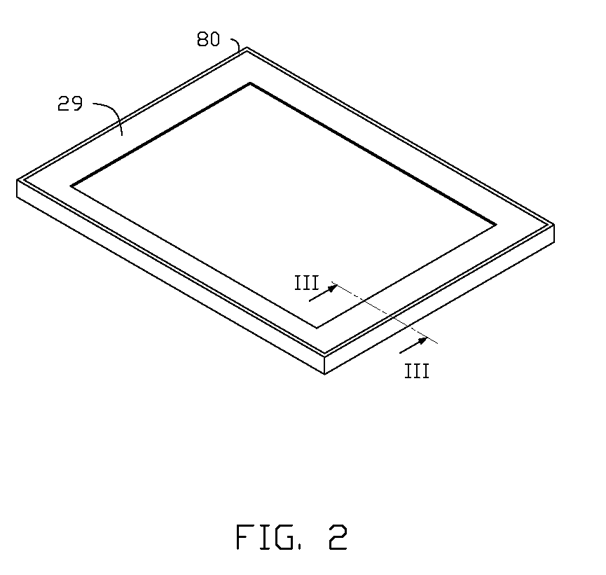

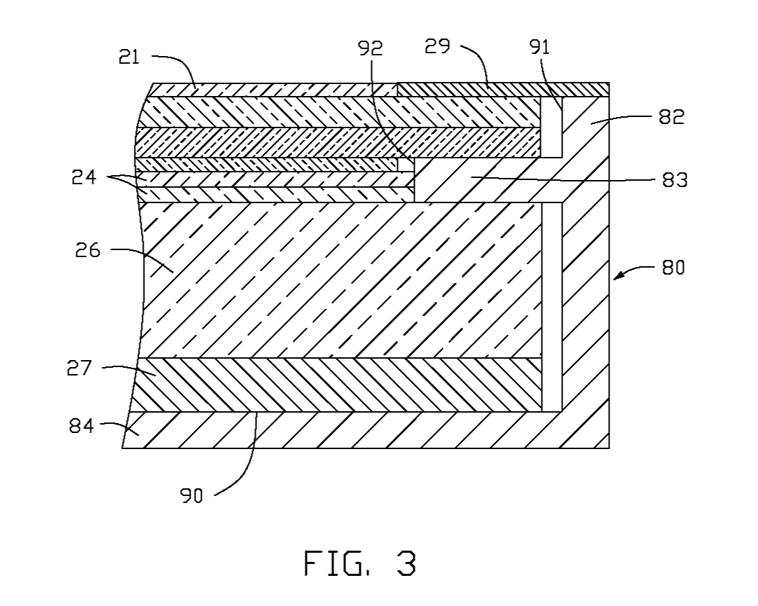

Referring to FIG. 2 and FIG. 3, FIG. 2 is an assembly view of part of the LCD device 2, and FIG. 3 is a cross-section of FIG. 2 taken along line III-III. When the LCD device 2 is assembled, first, an external force applied on the second frame 80 deforms the four sides 82 elastically, whereby the space 90 therein accordingly increases. Thus, even though the extending portion 83 forms an obstruction, the reflector 27, the light guide plate 26, and the light source 25 can be assembled in a space between the extending portion 83 and the bottom plate 84 through the second opening 92. The reflector 27 is disposed on the bottom plate 84, the light plate guide 26 is disposed on the reflector 27, and the bottom surface 263 is adjacent to and faces the reflector 27. The light source 25 is disposed adjacent to the light incident surface 261. The optical films 24 are disposed at the second opening 92 and on the light incident surface 261, and edges of the optical films 24 abut an edge of the extending portion 83. The liquid crystal panel 21 is disposed on the extending portion 83 and is supported by the extending portion 83. Light-shielding tape 29 is disposed on a common top of the four sides 82 and abuts an edge of the liquid crystal panel 21. The light-shielding tape 29 can further fix the liquid crystal panel 21. The light-shielding tape 29 may be attached on the common top of the four sides 82. Finally, the first frame 40 attaches to the second frame 80 to hold the LCD module 20. The light-shielding tape 29 is adjacent to the first frame 40.

Compared with a typical LCD device, the LCD device 2 utilizes the light-shielding tape 29 to fix the liquid crystal panel 21 to replace a front casing used in the typical LCD device, and disposes the side structure on the second frame 80 to replace a rear casing and a plastic frame used in the typical LCD device. The LCD device 2 decreases the number of components compared with a commonly used LCD device and can fulfill the holding requirements for the LCD module, decreasing manufacturing costs and raw material requirements, and reduces weight and thickness of the finished LCD device 2.

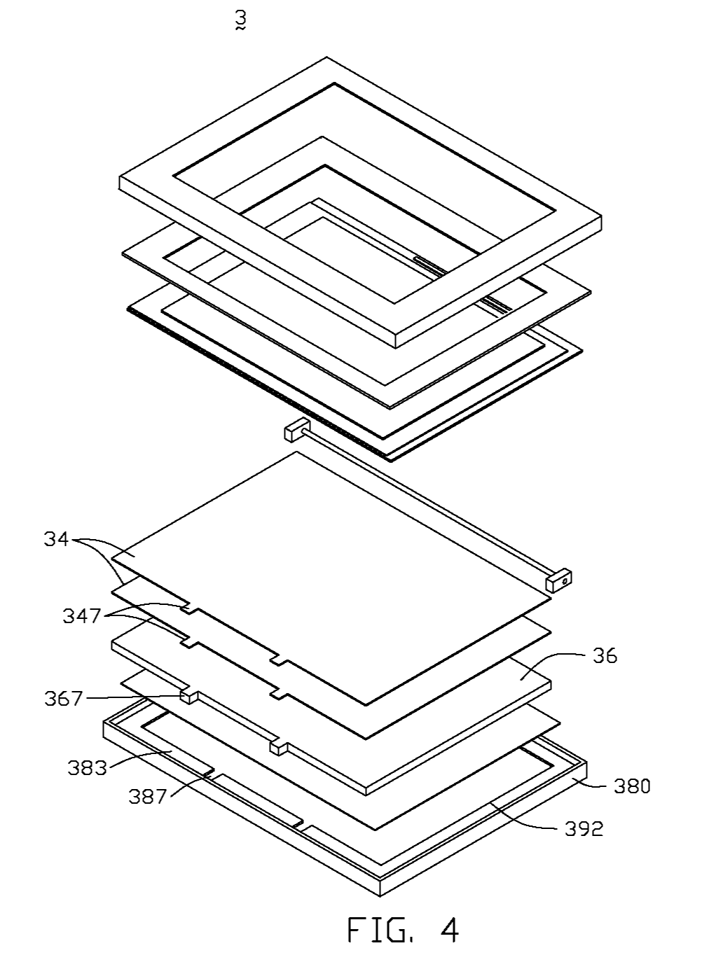

Referring to FIG. 4, an exploded view of a second embodiment of an LCD device 3 is shown, differing from the first embodiment only in that the light guide plate 36 of the LCD device 3 has a plurality of first protrusions 367 extending outward from a side thereof, the optical films 34 of the LCD device 3 have a plurality of second protrusions 347 extending outward from a side (not labeled) thereof. The extending portion 383 of the second frame 380 of the LCD device 3 has a plurality of holes 387 corresponding to the first protrusions 367 and the second protrusions 347. There may be fewer first protrusions 367 than second protrusions 347. The second protrusions 347 may overlap the first protrusions 367 after the LCD device 3 is assembled.

When the LCD device 3 is assembled, the first protrusions 367 of the light guide plate 36 pass through the holes 387, and the light guide plate 36 passes through a second opening 392 surrounded by the extending portion 383. At same time, the holes 387 receive the second protrusions 347 to fix the optical films 34. Therefore, the optical films 34 can be oriented by the engagement of the holes 387 and the second protrusions 347, and an error for assembling the light guide plate 36 can be avoided. Further, the light guide plate 36 can pass through the second opening 392 with no elastic deformation of the second frame 380 since the holes 387 allow first protrusions 367 of the light guide plate 36 to pass therethrough.

In an alternative embodiment, a reflecting material can be disposed on an inner surface of the side structure under the extending portion and an inner surface of the bottom plate of the second frame. Therefore, the reflector can be omitted. Thickness of the light guide plate is substantially equal to the distance between the extending portion and the bottom plate.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A liquid crystal display (LCD) device, comprising:
a first frame;
a second frame; and
an LCD module received cooperatively in the first and the second frames, the LCD module comprising a liquid crystal panel and a backlight module;
wherein the second frame comprises a bottom plate and a side structure substantially extending from the bottom plate, a space comprising a first opening defined by the side structure and the bottom plate, an extending portion that extends from the side structure toward the space, wherein the backlight module is disposed on the bottom plate, and the liquid crystal panel is disposed on and supported by the extending portion.

2. The LCD device of claim 1, wherein the extending portion is parallel to the bottom plate.

3. The LCD device of claim 2, wherein a second opening is surrounded by the extending portion, and an area of the second opening is less than that of the first opening.

4. The LCD device of claim 1, wherein the side structure and the bottom plate are integrally formed.

5. The LCD device of claim 1, wherein the side structure comprises four sides connected end to end, and the space comprising the first opening is surrounded by the four sides and the bottom plate.

6. The LCD device of claim 1, wherein the space comprising the first opening is substantially rectangular, and a capacity of the space is substantially the same as a volume of the LCD module.

7. The LCD device of claim 1, further comprising a light-shielding tape, wherein the light-shielding tape is disposed on a top of the side structure, abuts an edge of the liquid crystal panel, and is adjacent to the first frame.

8. The LCD device of claim 1, wherein the backlight module comprises a plurality of optical films and a light guide plate disposed between the extending portion and the bottom plate, and the plurality of optical films abut an edge of the extending portion.

9. The LCD device of claim 8, wherein a thickness of the plurality of optical films is less than that of the extending portion.

10. The LCD device of claim 8, wherein the backlight module further comprises a reflector disposed between the light guide plate and the bottom plate.

11. The LCD device of claim 10, wherein a sum of a thickness of the light guide plate and a thickness of the reflector is substantially equal to a distance between the extending portion and the bottom plate.

12. The LCD device of claim 8, wherein a reflecting material is disposed on an inner surface of the side structure under the extending portion and an inner surface of the bottom plate of the second frame.

13. The LCD device of claim 12, wherein a thickness of the light guide plate is substantially equal to a distance between the extending portion and the bottom plate.

14. The LCD device of claim 8, wherein the light guide plate comprises a plurality of first protrusions extending outward from a side of the light guide plate, the optical films comprise a plurality of second protrusions extending outward from a side of the plurality of optical films, and the extending portion comprises a plurality of holes corresponding to the first protrusions and the second protrusions.

15. The LCD device of claim 14, wherein the plurality of second protrusions respectively overlap the plurality of first protrusions.

16. The LCD device of claim 1, wherein the side structure is made of plastic and the bottom plate of the second frame is made of metal.

17. A liquid crystal display (LCD) device, comprising:
a first frame;
a second frame; and
a LCD module received cooperatively by the first and the second frames, the LCD module comprising a liquid crystal panel and a backlight module;
wherein the second frame comprises a bottom plate and a side structure substantially extending from the bottom plate, a space comprising a first opening is defined by the side structure and the bottom plate, an extending portion that extends from the side structure toward the space and form a second opening, the backlight module is disposed on the bottom plate through the second opening, and the liquid crystal panel is disposed on and supported by the extending portion.

18. The LCD device of claim 17, wherein the extending portion is parallel to the bottom plate, and has a determined distance from the bottom plate.

19. The LCD device of claim 18, further comprising a light-shielding tape, wherein the light-shielding tape is disposed on a top of the side structure, abuts an edge of the liquid crystal panel, and is adjacent to the first frame.
